(19) United States
(12) Patent Application Publication
(10) Pub. No.: US 2018/0055725 A1
(43) Pub. Date: Mar. 1, 2018

(54) SYSTEM FOR SLEEP AID

(71) Applicant: Mykal Mitchell, Galesburg, IL (US)

(72) Inventor: Mykal Mitchell, Galesburg, IL (US)

(21) Appl. No.: 15/253,584

(22) Filed: Aug. 31, 2016

(51) Int. Cl. A61H 23/00; A47G 9/10; H04R 1/02

(52) U.S. Cl. CPC A61H 23/00; A47G 2009/006; H04R 1/028; A47G 9/1045

(57) ABSTRACT

A sleep aid system that includes: a curved neck pillow; speakers within the neck pillow; a vibrator embedded within the neck pillow; and a means to control functions related to the pillow. Preferably, the means to control includes a remote control, where said remote control includes a control panel and a display panel. The control panel includes audio controls to control audio output to these speakers.

### BACKGROUND OF THE INVENTION

### Field of Invention

The present invention relates to a system in the form of a neck pillow used to provide a sleeping aid for users.

### Description of Related Art

Sleep is a critical component of any individual's lifestyle and keeping a regular sleep schedule helps to maintain an overall healthy lifestyle. Many individuals suffer from sleeping disorders due to various factors such as stress, overwork and bad eating habits. As a result, many individuals resort to various techniques to assist in falling asleep and to maintain sleep over an adequate period of time. These techniques may include implementing certain mattresses, sleeping pillows, drinking teas, taking medication and other known products and techniques to encourage falling and maintaining an undisturbed sleep. As a result, it would be advantageous to have yet another option for users to assist in maintaining sleep.

### SUMMARY OF THE INVENTION

The present invention relates to a sleep aid system that includes: a curved neck pillow; speakers within the neck pillow; a vibrator embedded within the neck pillow; and a means to control functions related to the pillow. Preferably, the means to control includes a remote control, where said remote control includes a control panel and a display panel. The control panel includes audio controls to control audio output to these speakers.

### BRIEF DESCRIPTION OF DRAWINGS

FIG. 1 depicts a remote controller used in accordance with the present invention.

FIG. 2 depicts a curved neck pillow used in accordance with the present invention.

### DETAILED DESCRIPTION

The present invention relates to a sleep aid system that utilizes a curved neck pillow in conjunction with a remote controller to assist the user in falling asleep. The curved neck pillow in accordance with the present invention includes speakers in the pillow to provide audio sound emitting from the pillow. Further, a vibrator is embedded within the pillow to provide light vibration to add a means to assist in sleep encouragement. The audio and vibration are controlled by a remote controller utilized by a user. The remote controller includes control mechanisms for operation of volume and even heart pulsing sounds.

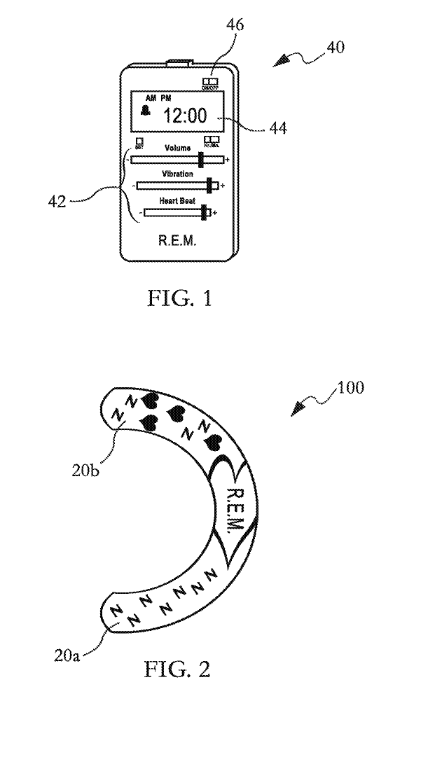

In reference FIG. 1, a Remote Control 40 is shown in accordance with the present invention. The Remote Control 40 includes a Digital Display 44, which displays time for the user. Below the Digital Display 44 is a Control Panel 42 that includes a number control mechanism. These control features relate to a Curved Neck Pillow 100 shown in FIG. 2. The Curved Neck Pillow 100 is curved to fit around a user's neck to assist in encouraging sleep. The Neck Pillow 100 includes Speakers 20a, 20b on each end of the Neck Pillow 100. Embedded within the Neck Pillow 100 is a vibrator, not shown, which provides a light vibration to further assist the user to drift into a deep sleep. The intensities and volume associated with the vibration and audio provided by the Neck Pillow 100 are controlled by the Remote Control 40. During use, the user simply places the Pillow 100 around the neck and activates the desired controls provided on the remote controller. The Neck Pillow 100 further includes heartbeat sounds through the speakers that have a natural and calming effect on the user of the Neck Pillow 100. Audio sound can be in any form or manner desired by the user and can range from easy listening music to soothing natural sounds all to assist in encouraging sleep for the user. The instant invention has been shown and described in what it considers to be the most practical and preferred embodiments. It is recognized, however, that departures may be made there from within the scope of the invention and that obvious modifications will occur to a person skilled in the art.

What is claimed is:

1. A sleep aid system comprising:
a. a curved neck pillow;
b. speakers within the neck pillow;
c. a vibrator embedded within the neck pillow; and
d. a means to control functions related to the pillow.

2. The sleep aid system according to claim 1, further including a remote control as the means to control functions related to the pillow

3. The sleep aid system according to claim 2, where said remote control includes a control panel.

4. The sleep aid system according to claim 3, where the control panel includes audio controls to control audio output to these speakers.

5. The sleep aid system according to claim 3, where the remote control includes a display panel.

6. The sleep aid system according to claim 5, where the display panel includes a time display.

7. The sleep aid system according to claim 2, where the remote control includes an alarm.
